(19) United States
(12) Patent Application Publication
(10) Pub. No.: US 2013/0040585 A1
(43) Pub. Date: Feb. 14, 2013

(54) RADIO COMMUNICATION APPARATUS AND REFLECTED WAVE ACQUISITION METHOD

(71) Applicants: Shigeru OKAWA, Sendai (JP); Osamu KURODA, Sendai (JP)

(72) Inventors: Shigeru OKAWA, Sendai (JP); Osamu KURODA, Sendai (JP)

(73) Assignee: FUJITSU LIMITED, Kawasaki-shi (JP)

(21) Appl. No.: 13/606,042

(22) Filed: Sep. 7, 2012

Related U.S. Application Data
(63) Continuation of application No. PCT/JP2010/054205, filed on Mar. 12, 2010.

(51) Int. Cl. H04B 1/04

(52) U.S. Cl. 455/101

(57) ABSTRACT

A first output device has a first port, a second port, and a third port, and outputs from the second port a transmission signal supplied to the first port. A second output device has the same ports as those of the first output device, outputs from the second port the transmission signal supplied to the first port from the first output device, and outputs from the third port a reflected wave supplied to the second port from an antenna. A phase shifter inverts a phase of a signal output from the third port of the first output device. An adder adds a signal output from the third port of the second output device and a signal output from the phase shifter.

### CROSS-REFERENCE TO RELATED APPLICATION

This application is a continuation application of International Application PCT/JP2010/54205 filed on Mar. 12, 2010 and designated the U.S., the entire contents of which are incorporated herein by reference.

### FIELD

The embodiments discussed herein are related to a radio communication apparatus which detects a VSWR (Voltage Standing Wave Ratio) of an antenna and a reflected wave acquisition method for the radio communication apparatus.

### BACKGROUND

An antenna of a base station in a radio communication system is an important element which connects a radio transmission/reception circuit and a space, and a failure of the antenna gives a large impact to the entire system. Accordingly, that a failure of the antenna is known as sooner as possible or predicted is important in terms of operations of the radio communication system.

For example, when looseness is generated in a connector connected to an antenna of a radio communication apparatus or damage occurs in a cable or antenna, an impedance matching between a circuit and the antenna is shifted. When the impedance matching is shifted, reflected wave of transmission signals in the antenna increases and a VSWR increases according to the shift of the impedance matching. Accordingly, when monitoring a VSWR, the radio communication apparatus detects or predicts a failure of the antenna.

There is proposed a device for eliminating interference between transmission and reception which eliminates interference with a reception signal due to leakage of a transmission signal (see, for example, Japanese Laid-open Patent Publication No. 09-116459).

A VSWR is calculated, for example, based on power or voltage of transmission signals and reflected waves. Therefore, there is a problem that when an unnecessary signal is included in acquired reflected waves and accuracy is low, an appropriate VSWR fails to be calculated.

### SUMMARY

In one aspect of the embodiments, a radio communication apparatus to perform radio communication includes: a first output device including a first port, a second port, and a third port, and configured to output from the second port a transmission signal supplied to the first port; a second output device including a first port, a second port, and a third port, and configured to output from the second port the transmission signal supplied to the first port, and output from the third port a reflected wave supplied to the second port from an antenna; a phase shifter configured to invert a phase of a signal output from the third port of the first output device; and an adder configured to add one signal output from the third port of the second output device and another signal output from the phase shifter.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a radio communication apparatus according to a first embodiment;

FIG. 2 is a block diagram illustrating a radio communication apparatus according to a second embodiment;

FIG. 3 illustrates a reflected wave;

FIG. 4 illustrates a resultant wave of a reflected wave and an unnecessary wave;

FIG. 5 illustrates a resultant wave of a reflected wave, an unnecessary wave, and a phase-inverted unnecessary wave;

FIG. 6 is part 1 of a diagram illustrating a power difference between a reflected wave and a resultant wave;

FIG. 7 is part 2 of a diagram illustrating a power difference between a reflected wave and a resultant wave;

FIG. 8 is part 1 of a diagram illustrating a power difference between a reflected wave and a resultant wave from which an unnecessary wave is eliminated;

FIG. 9 is part 2 of a diagram illustrating a power difference between a reflected wave and a resultant wave from which an unnecessary wave is eliminated;

FIG. 10 illustrates an error of reflected wave power;

FIG. 11 is a block diagram illustrating a radio communication apparatus according to a third embodiment;

FIG. 12 illustrates SW control of a VSWR calculator; and

FIG. 13 is a flowchart illustrating a calculation operation of a VSWR.

### DESCRIPTION OF EMBODIMENTS

A first embodiment will now be described in detail below with reference to the accompanying drawings, wherein like reference numerals refer to like elements throughout.

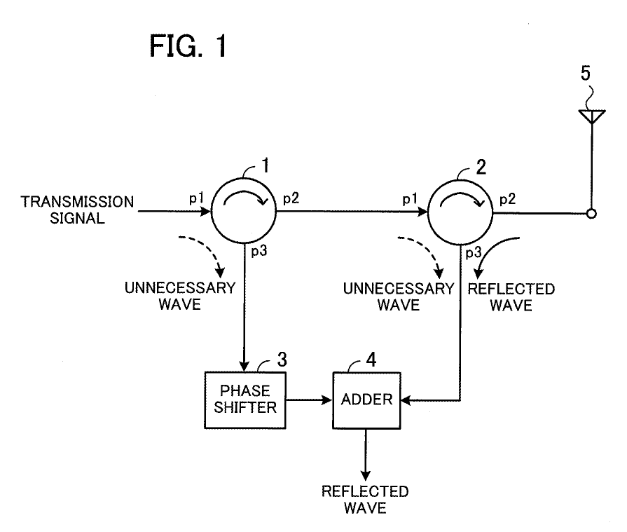

FIG. 1 is a block diagram illustrating a radio communication apparatus according to the first embodiment. As illustrated in FIG. 1, the radio communication apparatus includes output devices 1 and 2, a phase shifter 3, an adder 4, and an antenna 5.

Examples of the output device 1 include a circulator, and the output device 1 has ports p1 to p3. The output device 1 outputs from the port p2 a transmission signal supplied to the port p1.

Examples of the output device 2 include a circulator, and the output device 2 has the same ports p1 to p3 as those of the output device 1. The output device 2 outputs from the port p2 a transmission signal from the output device 1 supplied to the port 1, and outputs from the port p3 a reflected wave from the antenna 5 supplied to the port p2.

The phase shifter 3 inverts a phase of a signal output from the port p3 of the output device 1.

The adder 4 adds a signal output from the port p3 of the output device 2 and a signal output from the phase shifter 3.

The antenna 5 is connected to the port p2 of the output device 2. In the antenna 5, a reflected wave is caused by transmission signals according to a mismatch between impedance of the antenna 5 and impedance at the time when viewing circuits in the radio communication apparatus from the antenna 5.

Here, it is preferred that each of the output devices 1 and 2 does not output from the port p3 a transmission signal supplied to the port p1. However, as indicated in dotted arrows of FIG. 1, a part of the transmission signals supplied to the port 1 is output as an unnecessary wave. Therefore, from the port p3 of the output device 2, a resultant wave in which a reflected wave and an unnecessary wave are added is output and the high-accuracy reflected wave is not acquired.

However, the phase shifter 3 inverts a phase of the unnecessary wave output from the port p3 of the output device 1, and supplies it to the adder 4. The adder 4 adds the unnecessary wave a phase of which is inverted by the phase shifter 3 to the resultant wave of the unnecessary wave and reflected wave output from the port p3 of the output device 2, and therefore the high-accuracy reflected wave in which the unnecessary wave is eliminated is acquired from the adder 4. The process permits the radio communication apparatus to calculate an appropriate VSWR.

As can be seen from the above description, the radio communication apparatus adds a signal from the output device 1 in which a phase is inverted by the phase shifter 3 to a signal output from the port p3 of the output device 2. The process permits the radio communication apparatus to acquire a high-accuracy reflected wave in which the unnecessary wave is eliminated.

A second embodiment will be described in detail below with reference to the accompanying drawings.

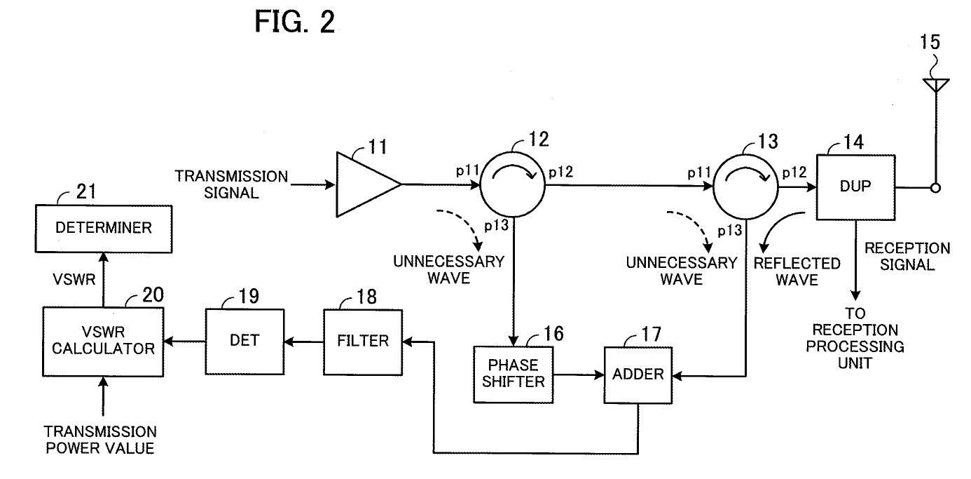

FIG. 2 is a block diagram illustrating a radio communication apparatus according to the second embodiment. As illustrated in FIG. 2, the radio communication apparatus includes an amplifier 11, circulators 12 and 13, a DUP (Duplexer) 14, an antenna 15, a phase shifter 16, an adder 17, a filter 18, a DET (Detector) 19, a VSWR calculator 20, and a determiner 21. The radio communication apparatus of FIG. 2 is mounted, for example, on a base station, and performs radio communication with a cellular phone.

The amplifier 11 amplifies a transmission signal to be transmitted by radio to a cellular phone.

The circulator 12 is a circulator including ports p11 to p13. The circulator 12 outputs from the port p12 a signal supplied to the port p11, outputs from the port p13 a signal supplied to the port p12, and outputs from the port p11 a signal supplied to the port p13. Accordingly, the circulator 12 outputs from the port p12 a transmission signal from the amplifier 11 supplied to the port pll.

The circulator 13 is a circulator including the same ports p11 to p13 as those of the circulator 12. Accordingly, the circulator 13 outputs from the port p12 the transmission signal from the circulator 12 supplied to the port p11. The circulator 13 further outputs from the port p13 the transmission signal (hereinafter, it may be referred to as a reflected wave) reflected by the antenna 15 supplied to the port p12.

It is preferred that the circulator 13 outputs from the port p12 a transmission signal supplied to the port p11 and fails to output it from the port p13; however, a part of the transmission signals are output from the port p13 as an unnecessary wave. The circulator 12 is a matched pair circulator having the same characteristics as that of the circulator 13, and in the same manner as in the circulator 13, outputs from the port p13 a part of the transmission signals supplied to the port p11 as an unnecessary wave.

The matched pair means that both circulators are manufactured at the same time and by the same elements, and have the same characteristics as each other.

Accordingly, a phase and amplitude of the unnecessary wave output from the port p13 of the circulator 12 are approximately the same as those of the unnecessary wave output from the port p13 of the circulator 13.

The DUP 14 is an antenna duplexer, and supplies to the antenna 15 a transmission signal output from the port p12 of the circulator 13. On the other hand, the DUP supplies to a reception processing unit a signal received by the antenna 15. For example, the reception processing unit performs demodulation processing of the received signal and supplies it to an upper device of the base station.

The antenna 15 transmits by radio a transmission signal output from the DUP 14 to, for example, a cellular phone, and receives a radio signal transmitted from the cellular phone. Impedance of the antenna 15 is matched with that of circuits (hereinafter, circuits within the radio communication apparatus) viewed from the output side of the DUP 14.

When the deviation occurs in an impedance matching between the antenna 15 and the circuits within the radio communication apparatus, a reflected wave occurs in the antenna 15 according to the deviation of the matching. For example, when looseness is generated in a connector connected to the antenna 15, or when damage occurs in a cable or antenna, a reflected wave occurs. The reflected wave is supplied to the port p12 of the circulator 13 through the DUP 14, and is output from the port p13 of the circulator 13 to the adder 17.

The phase shifter 16 inverts a phase of the unnecessary wave output from the port p13 of the circulator 12. Specifically, the phase shifter 16 rotates by 180 degrees a phase of the unnecessary wave output from the circulator 12.

The adder 17 adds the phase-inverted unnecessary wave output from the phase shifter 16 and the resultant wave of the unnecessary wave and reflected wave output from the circulator 13. Here, the unnecessary wave included in the resultant wave output from the circulator 13 has the same amplitude as that of the unnecessary wave output from the phase shifter 16, and both the phases are different from each other by 180 degrees. Accordingly, the reflected wave in which the unnecessary wave is eliminated is output from the adder 17.

The filter 18 extracts the reflected wave output from the adder 17, and supplies it to the DET 19. For example, the filter 18 is a band pass filter having a frequency of the reflected wave as a pass band.

The DET 19 measures reflected wave power of the reflected wave output from the filter 18. The VSWR calculator 20 calculates a VSWR based on the reflected wave power output from the DET 19 and the transmission power of the transmission signal. Note that the transmission power of the transmission signal is previously known, for example, at the time of design.

The VSWR calculator 20 calculates a VSWR by using the following formulae (1) and (2).

$$\begin{matrix}ρ = \frac{1 + \vert γ \vert}{1 - \vert γ \vert} & ( 1 ) \\ γ = \sqrt{\frac{{P}_{r}}{{P}_{f}}} & ( 2 )\end{matrix}$$

Here, ρ of the formula (1) represents a VSWR. Pᵣ of the formula (2) represents reflected wave power, and P_{f} of the formula (2) represents transmission power.

Based on the VSWR calculated by the VSWR calculator 20, the determiner 21 detects or predicts a failure of the antenna 15. For example, if the VSWR calculated by the VSWR calculator 20 is larger than a predetermined threshold, the determiner 21 determines that looseness is generated in a connector connected to an antenna of the radio communication apparatus or damage is caused in a cable or antenna.

A reflected wave, an unnecessary wave, and elimination of the unnecessary wave will be described below.

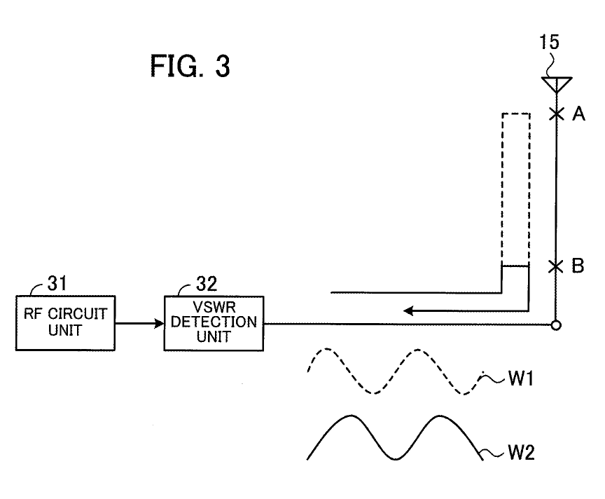

FIG. 3 illustrates a reflected wave. In FIG. 3, the antenna 15 of the radio communication apparatus illustrated in FIG. 2 is illustrated. An RF (Radio Frequency) circuit unit 31 of FIG. 3 corresponds to the amplifier 11 and reception processing unit illustrated in FIG. 2. In addition, the RF circuit unit 31 corresponds to a circuit which performs modulation processing of transmission signals in a prestage of the amplifier 11 and which is not illustrated in FIG. 2.

The VSWR detection unit 32 of FIG. 3 corresponds to the circulators 12 and 13, DUP 14, phase shifter 16, adder 17, filter 18, DET 19, VSWR calculator 20, and determiner 21 illustrated in FIG. 2.

A waveform W1 illustrated in FIG. 3 indicates a waveform of the reflected wave in the case where a transmission signal is reflected at an A point of the antenna 15. A waveform W2 illustrated in FIG. 3 indicates a waveform of the reflected wave in the case where a transmission signal is reflected at a B point of the antenna 15.

A level of the reflected wave is different according to looseness of a connector connected to an antenna of the radio communication apparatus or damage of cables and an antenna. Specifically, the level of the reflected wave is different according to a degree of the mismatch between the circuits within the radio communication apparatus and the antenna 15.

The phase of the reflected wave is different depending on a point in which a mismatch is caused by the antenna 15. For example, a waveform of the reflected wave reflected at the A point of the antenna 15 is as indicated in the waveform W1, and a waveform of the reflected wave reflected at the B point is as indicated in the waveform W2, that is, the phases of the reflected waves are different from each other based on the reflected points.

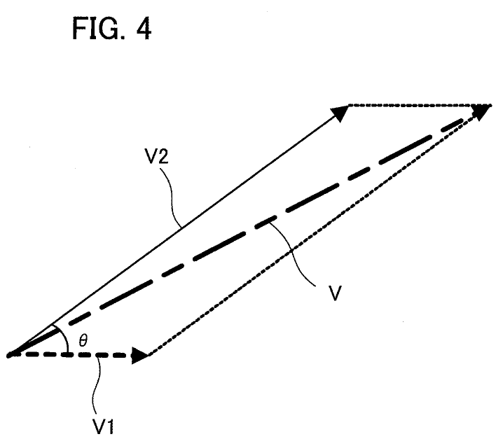

FIG. 4 illustrates a resultant wave of the reflected wave and the unnecessary wave. The reflected wave reflected by the antenna 15 is supplied to the port p12 of the circulator 13 and is output from the port p13 to the adder 17. Since the circulator 13 also supplies a part of the transmission signals to the adder 17 as an unnecessary wave, a resultant wave in which the reflected wave and the unnecessary wave are added is supplied to the adder 17.

A vector V1 of FIG. 4 indicates a vector of the unnecessary wave supplied to the adder 17 from the circulator 13. A vector V2 indicates a vector of the reflected wave supplied to the adder 17 from the circulator 13. Accordingly, a resultant wave of a vector V in which the vectors V1 and V2 are added is output from the circulator 13.

Here, when a phase angle at the time of adding the vector V1 of the unnecessary wave and the vector V2 of the reflected wave is set to 8, a size of the resultant wave is represented by the following formula (3).

V=\sqrt{(V1+V2 cos θ)²+(V2 sin θ)²} (3)

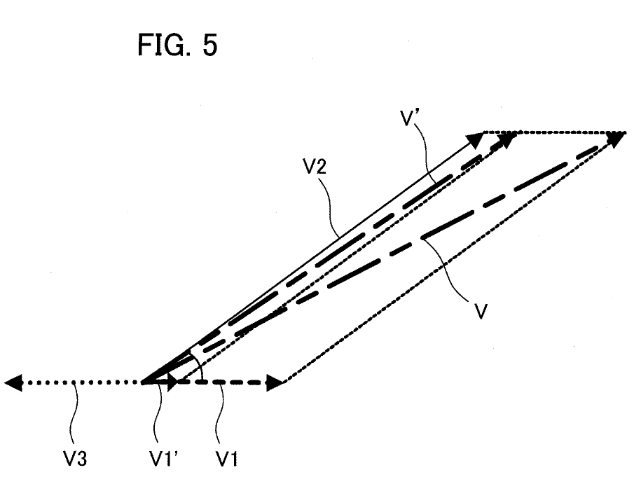

FIG. 5 illustrates a resultant wave of a reflected wave, an unnecessary wave, and the phase-inverted unnecessary wave. The resultant wave output from the circulator 13 is supplied to the adder 17, and the adder 17 adds the phase-inverted unnecessary wave output from the phase shifter 16 to the resultant wave output from the circulator 13.

A vector V3 illustrated in FIG. 5 indicates an unnecessary wave output from the phase shifter 16. In the unnecessary wave output from the phase shifter 16, a phase is rotated by 180 degrees toward the unnecessary wave (vector V1) included in the resultant wave from the circulator 13.

Accordingly, the unnecessary wave included in the output from the port p13 of the circulator 13 is eliminated by the adder 17 as indicated in the vector V1′ of FIG. 5. From the adder 17, the resultant wave of the vector V′ in which the vectors V1′ and V2 are added is output.

The circulators 12 and 13 are matched pair, and preferably have the same characteristics; however, really have some deviations. Depending on the characteristics of the phase shifter 16 or lines on which a signal propagates, amplitude of the unnecessary wave output from the phase shifter 16 and that of the unnecessary wave included in the output from the circulator 13 are deviated in some degree. Accordingly, as indicated in the vector V1′ of FIG. 5, some unnecessary waves may be left in the output from the adder 17.

In FIG. 5, the vector V of the resultant wave in the case where the unnecessary wave included in the output from the circulator 13 is not eliminated is illustrated. Namely, in FIG. 5, the vector V of the resultant wave from the port p13 of the circulator 13 is illustrated. As compared with this vector V, as illustrated in FIG. 5, the vector V′ of the resultant wave output from the adder 17 is approximated to the vector V2 of the reflected wave. In short, the high-accuracy reflected wave is output from the adder 17.

Here, when a phase angel at the time of adding the vector V1′ in which the unnecessary wave is eliminated and the vector V2 of the reflected wave is set to θ, a size of the resultant wave is represented by the following formula (4).

V′=\sqrt{{(V1−V1′)+V2 cos θ}²+(V2 sin θ)²} (4)

In the formula (4), when sizes of the vectors V1 and V1′ are the same, a size of the vector V′ is equal to only a size of the reflected wave. That is, when the unnecessary wave having the same level and a phase difference of 180 degrees is output from the phase shifter 16 toward the unnecessary wave included in the output from the circulator 13, only the reflected wave is output from the adder 17.

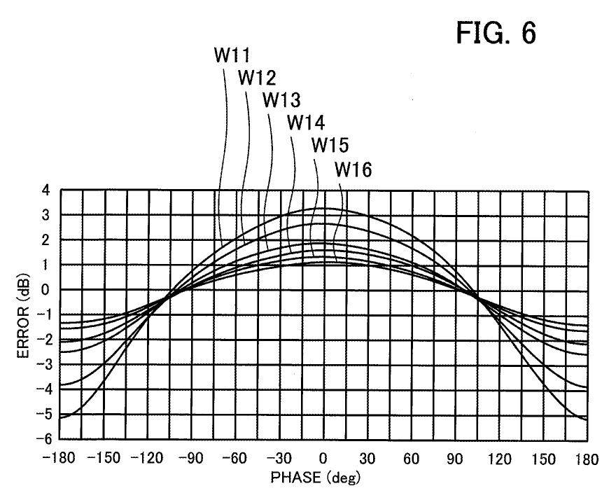

FIG. 6 is part 1 of a diagram illustrating power difference between the reflected wave and the resultant wave. The horizontal axis of FIG. 6 represents a phase difference between the reflected wave and unnecessary wave of the resultant wave output from the port p13 of the circulator 13. The vertical axis represents a power difference between the reflected wave and the resultant wave output from the port p13 of the circulator 13.

Waveforms W11 to W16 of FIG. 6 indicate a measurement error of the reflected wave to the resultant wave in the case where power of the unnecessary wave is attenuated by 25 dB relative to power of the transmission signal. The waveform W11 of FIG. 6 further indicates a measurement error of the reflected wave to the resultant wave in the case where power of the reflected wave is attenuated by 16 dB relative to power of the transmission signal. Much the same is true on the following attenuation values, and the waveforms W12 to W16 of FIG. 6 indicate a measurement error of the reflected wave to the resultant wave in the case where power of the reflected wave is attenuated relative to power of the transmission signal by 14 dB, 10.9 dB, 9.5 dB, 7.4 dB, and 6 dB, respectively.

In the resultant wave output from the port p13 of the circulator 13, a power difference between its own wave and the reflected wave is caused by the phase difference between the reflected wave and the unnecessary wave as illustrated in FIG. 6. Specifically, in the resultant wave output from the circulator 13, the power difference between its own wave and the reflected wave is different depending on a reflection point of the reflected wave in the antenna 15. When a phase difference between the reflected wave and the unnecessary wave is 0 degree and 180 degrees, the power difference between the resultant wave and reflected wave output from the circulator 13 is maximized.

It is seen from FIG. 6 that as power of the reflected wave is smaller, namely, as a rate of the unnecessary wave in the resultant wave is larger, a measurement error between the resultant wave and reflected wave output from the circulator 13 is larger. As indicated in the waveforms W11 and W16, for example, the measurement error of the reflected wave attenuated by 6 dB relative to the transmission signal is larger than the measurement error of the reflected wave attenuated by 16 dB relative to the transmission signal.

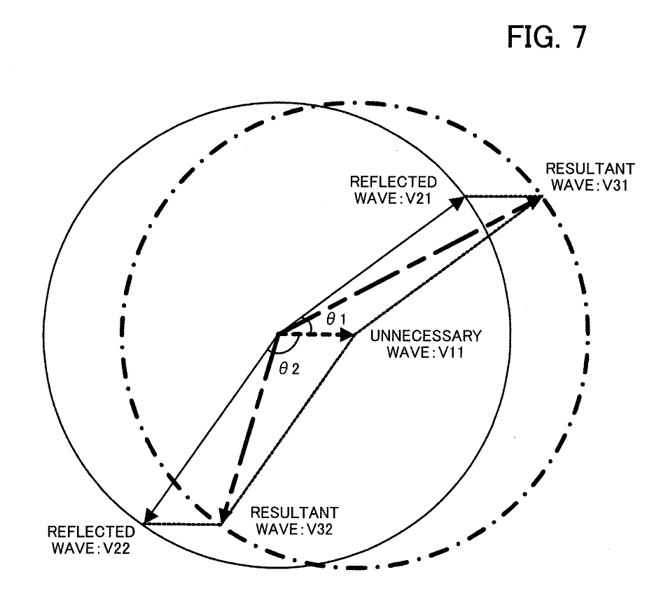

FIG. 7 is part 2 of a diagram illustrating a power difference between the reflected wave and the resultant wave. In FIG. 7, a vector V31 of the resultant wave through a phase difference θ1 between the unnecessary wave (vector V11) and the reflected wave (vector V21) is illustrated. In addition, a vector V32 of the resultant wave through a phase difference θ2 between the unnecessary wave (vector V11) and the reflected wave (vector V22) is illustrated. When a phase of the reflected wave to the unnecessary wave is changed, a vector of the resultant wave changes as indicating a circle of chain line of FIG. 7.

A circle indicated by a solid line indicates a locus of a vector of the resultant wave output from the circulator 13 in the case where the unnecessary wave is not present. Namely, the circle indicated by a solid line indicates a locus of a vector of only the reflected wave.

As indicated in two circles of FIG. 7, a power difference to the reflected wave is caused by the unnecessary wave in the resultant wave output from the circulator 13. When a phase between the unnecessary wave and the reflected wave is 0 degree and 180 degrees, a power difference between the resultant wave and reflected wave output from the circulator 13 is maximized. As power of the reflected wave is smaller, the circle indicated by a solid line is more separated from the circle indicated by a chain line, and a power difference between the resultant wave and reflected wave output from the circulator 13 is larger.

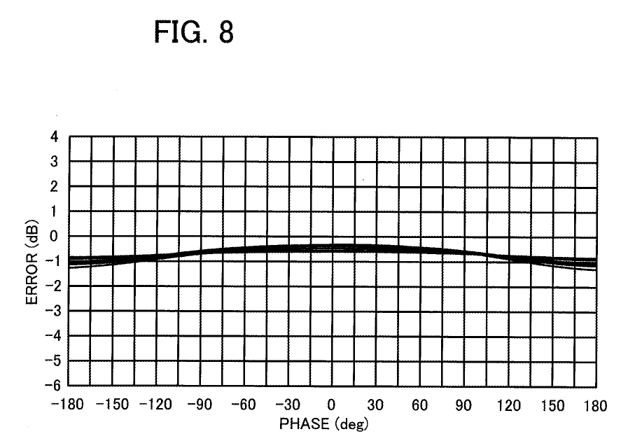

FIG. 8 is part 1 of a diagram illustrating a power difference between the reflected wave and the resultant wave from which the unnecessary wave is eliminated. The horizontal axis of FIG. 8 represents a phase difference between the reflected wave and unnecessary wave of the resultant wave output from the adder 17. The vertical axis represents a power difference between the reflected wave and the resultant wave output from the adder 17.

FIG. 8 illustrates a power difference between the reflected wave and the resultant wave in the case where power of the unnecessary wave is attenuated by 25 dB relative to power of the transmission signal. FIG. 8 further illustrates a power difference between the reflected wave and the resultant wave in the case where power of the reflected wave is attenuated relative to power of the transmission signal by 14 dB, 10.9 dB, 9.5 dB, 7.4 dB, and 6 dB.

In the resultant wave output from the adder 17, a power difference between its own wave and the reflected wave is caused by a phase difference between the reflected wave and the unnecessary wave as illustrated in FIG. 8. However, since the adder 17 adds the phase-inverted unnecessary wave to the resultant wave output from the circulator 13 for output, a power difference between the resultant wave and reflected wave output from the adder 17 is small. Specifically, in the resultant wave output from the adder 17, even if a reflection point of the reflected wave in the antenna 15 is any point, a power difference between its own wave and the reflected wave is small. In short, it is considered that the reflected wave itself is output from the adder 17.

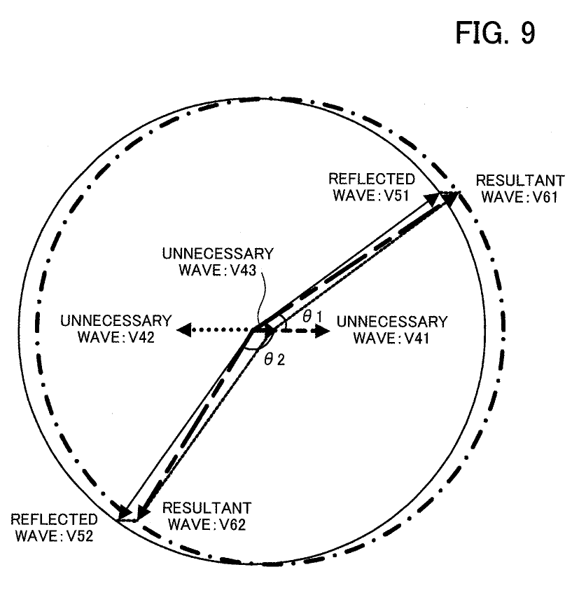

FIG. 9 is part 2 of a diagram illustrating a power difference between the reflected wave and the resultant wave from which the unnecessary wave is eliminated. FIG. 9 illustrates a vector V41 of the unnecessary wave included in the resultant wave output from the circulator 13, and a vector V42 of the phase-inverted unnecessary wave output from the phase shifter 16.

To the resultant wave output from the circulator 13, the unnecessary wave (vector V42) phase-inverted by the phase shifter 16 is added by the adder 17. Accordingly, the unnecessary wave included in the resultant wave output from the adder 17 is as indicated in the vector V43 of FIG. 9.

FIG. 9 illustrates a vector V61 of the resultant wave through a phase difference θ1 between the unnecessary wave (vector V43) and the reflected wave (vector V51). In addition, FIG. 9 illustrates a vector V62 of the resultant wave through a phase difference 82 between the unnecessary wave (vector V43) and the reflected wave (vector V52). When a phase of the reflected wave to the unnecessary wave (vector V43) is changed, a vector of the resultant wave changes as indicating a circle of chain line of FIG. 9.

A circle indicated by a solid line indicates a locus of a vector of only the reflected wave. A vector of the resultant wave output from the adder 17 changes as indicated in the circle of chain line, and the circle of chain line approximately overlaps with the circle of solid line. That is, it is considered that the reflected wave itself is output from the adder 17.

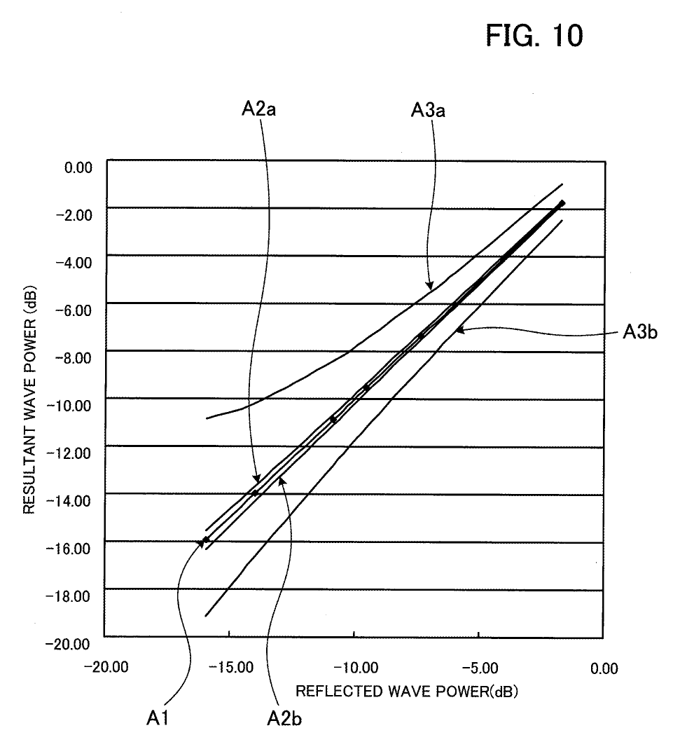

FIG. 10 illustrates an error of reflected wave power. The horizontal axis of FIG. 10 represents power of the reflected wave reflected by the antenna 15. Namely, the horizontal axis represents power of the reflected wave supplied to the port p12 of the circulator 13. The vertical axis represents power of the resultant wave output from the circulator 13 and that of the resultant wave output from the adder 17.

A waveform indicated in an arrow A1 indicates an ideal reflected wave to be output from the adder 17. For example, when the reflected wave power reflected by the antenna 15 is −10 dB, the resultant wave power of −10 dB is preferably output from the adder 17.

Waveforms indicated in arrows A2a and A2b indicate power of the resultant wave actually output from the adder 17. Power of the resultant wave (namely, the reflected wave) as in a waveform indicated in the arrow A1 is preferably output from the adder 17; however, deviations from an ideal reflected wave are caused in some degree by deviations of characteristics of the circulators 12 and 13.

Waveforms indicated in arrows A3a and A3b indicate power of the resultant waves output from the circulator 13. Since the unnecessary wave is not eliminated by the adder 17, power of the resultant wave output from the circulator 13 is largely different from the ideal reflected wave.

The reason that two waveforms appear as in the arrows A3a and A3b is, for example, that the reflected wave takes positive and negative values based on a phase of the reflected wave as illustrated in FIG. 6. Further, as power of the reflected wave is smaller, it is more separated from ideal reflected wave power. Much the same is true on the arrows A2a and A2b.

As can be seen from the above description, the radio communication apparatus is designed so as to add the unnecessary wave phase-inverted by the phase shifter 16 from the circulator 12 to the resultant wave of the unnecessary wave and reflected wave output from the port p13 of the circulator 13. The process permits the radio communication apparatus to acquire the high-accuracy reflected wave in which the unnecessary wave is eliminated.

The circulators 12 and 13 are designed so as to have the same characteristics as each other. Through the process, the unnecessary waves output from the ports p13 of the circulators 12 and 13 are the same as each other, and the unnecessary wave is eliminated with high accuracy from the resultant wave to acquire the reflected wave by using the adder 17. In addition, the high-accuracy reflected wave is acquired even to the change in environment due to temperature and moisture. Also in the case of changing frequencies of the transmission signal, the circulators 12 and 13 behave in the same manner. Therefore, the unnecessary waves taken out from the ports p13 are the same as each other, and the high-accuracy reflected wave is acquired.

In place of the circulators 12 and 13, a double circulator may be used. In this case, the circuit may be miniaturized.

A third embodiment will be described in detail below with reference to the accompanying drawings. In the second embodiment, the radio communication apparatus calculates the VSWR based on transmission power of the predetermined transmission signal. In the third embodiment, a radio communication apparatus measures transmission power of the transmission signal to be actually transmitted by radio to a communication partner and calculates a VSWR by using the measured transmission power.

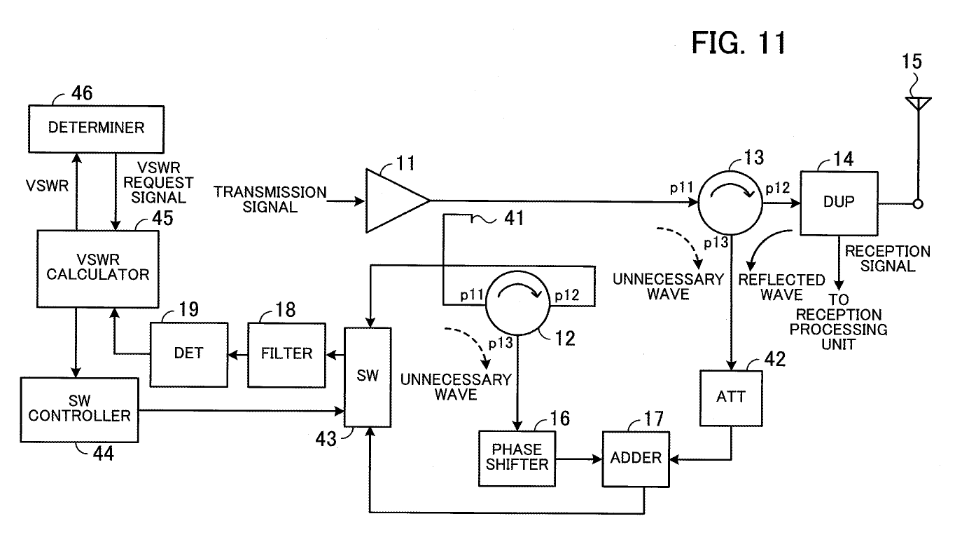

FIG. 11 is a block diagram illustrating the radio communication apparatus according to the third embodiment. In FIG. 11, the same circuit elements as those of FIG. 2 are indicated by the same reference numerals as in FIG. 2, and the description will not be repeated here. The radio communication apparatus of FIG. 11 includes a coupler 41, an ATT (ATTenuater) 42, a SW (SWitch) 43, a SW controller 44, a VSWR calculator 45, and a determiner 46.

The coupler 41 is connected to the output of the amplifier 11. The coupler 41 branches a part of the transmission signal output from the amplifier 11 and supplies it to the port pll of the circulator 12. The circulator 12 outputs from the port p12 the transmission signal supplied to the port p11 and supplies it to the SW 43. From the port p13 of the circulator 12, the unnecessary wave is further output as a part of the transmission signal supplied to the port p11.

A part of the transmission signal from the amplifier 11 is branched by the coupler 41 and supplied to the circulator 12. Accordingly, a level of the unnecessary wave output from the port p13 of the circulator 12 and that of the unnecessary wave output from port p13 of the circulator 13 are different from each other. To solve the problem, the ATT 42 attenuates the resultant wave output from the circulator 13 in such a manner that a level of the unnecessary wave output from the circulator 13 is the same as that of the unnecessary wave output from the circulator 12. Namely, the ATT42 compensates a branching level of the coupler 41.

To the SW 43, the transmission signal output from the port p12 of the circulator 12 and the resultant wave (reflected wave) from which the unnecessary wave is eliminated and which is output from the adder 17 are supplied. According to the control of the SW controller 44, the SW 43 supplies to the filter 18 one of the transmission signal output from the circulator 12 and the reflected wave output from the adder 17. According to the control of the VSWR calculator 45, the SW controller 44 switches a signal output from the SW 43.

The VSWR calculator 45 receives a VSWR request signal from the determiner 46 to control the SW controller 44 and calculates a VSWR based on the transmission signal and reflected wave output from the SW 43.

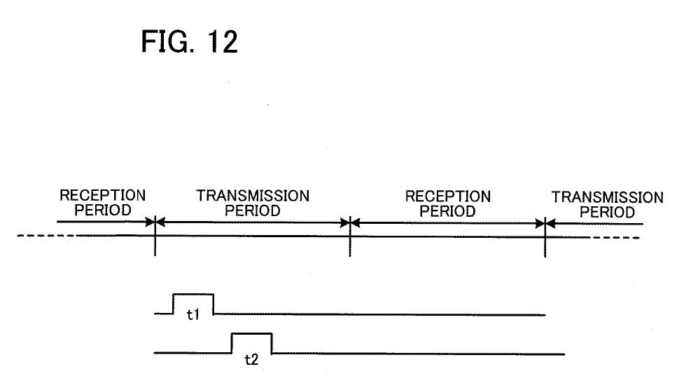

FIG. 12 illustrates the SW control of the VSWR calculator. FIG. 12 illustrates a transmission period during which the radio communication apparatus transmits a transmission signal and a reception period during which the radio communication apparatus receives a reception signal. The VSWR calculator 45 receives the VSWR request signal during the transmission period of the transmission signal. When receiving the VSWR request signal, for example, the VSWR calculator 45 instructs the SW controller 44 to control the transmission signal output from the SW 43 during a period t1 illustrated in FIG. 12. In addition, the VSWR calculator 45 instructs the SW controller 44 to control the reflected wave output from the SW 43 during a period t2 different from the period t1.

The VSWR calculator 45 calculates an average value of the transmission power output during the period t1 and an average value of the reflected wave power output during the period t2. The VSWR calculator 45 calculates a VSWR based on the average value of the calculated transmission power and reflected wave power.

The VSWR calculator 45 previously acquires (for example, stores it in a memory) the branching quantity of the transmission signal through the coupler 41, thereby compensating the transmission power. Further, the VSWR calculator 45 previously acquires the attenuation amount of the reflected wave through the ATT 42, thereby compensating the reflected wave power.

During the transmission period of the transmission signal, the determiner 46 supplies the VSWR request signal to the VSWR calculator 45. For example, the determiner 46 periodically outputs the VSWR request signal. Based on the VSWR from the VSWR calculator 45, the determiner 46 detects or predicts a failure of the antenna 15. For example, when the VSWR calculated by the VSWR calculator 45 is larger than a predetermined threshold, the determiner 46 determines that looseness is generated in the connector connected to the antenna of the radio communication apparatus or damage occurs in the cable or antenna.

In the same manner as in the determiner 46, the determiner 21 of FIG. 2 also supplies the VSWR request signal to the VSWR calculator 20 during the transmission period. The VSWR calculator 20 receives the VSWR request signal and calculates the VSWR, thereby supplying it to the determiner 21.

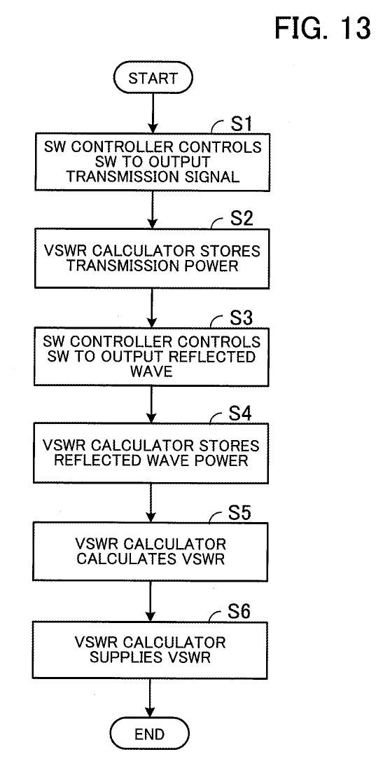

FIG. 13 is a flowchart illustrating a calculation operation of the VSWR.

(Step S1) Based on the instruction of the VSWR calculator 45, the SW controller 44 controls the SW 43 to output the transmission signal. Specifically, the SW controller 44 controls the SW 43 to output the transmission signal output from the circulator 12.

(Step S2) The VSWR calculator 45 stores the transmission power output from the DET 19. The VSWR calculator 45 stores the transmission power by a predetermined number.

(Step S3) When storing the transmission power by a predetermined number, the VSWR calculator 45 controls the SW controller 44 to output the reflected wave from the SW 43. Based on the instruction of the VSWR calculator 45, the SW controller 44 controls the SW 43 to output the reflected wave. Specifically, the SW controller 44 controls the SW 43 to output the reflected wave output from the adder 17.

(Step S4) The VSWR calculator 45 stores the reflected wave power output from the DET 19. The VSWR calculator 45 stores the reflected wave power by a predetermined number.

(Step S5) The VSWR calculator 45 calculates the VSWR based on the stored transmission power and reflected wave power. For example, the VSWR calculator 45 calculates average values of the transmission power and reflected wave power which are stored by a predetermined number and calculates the VSWR, respectively. Or, alternatively, the VSWR calculator 45 may receive the transmission power and the reflected wave power by one sample and calculate the VSWR. Specifically, the VSWR calculator 45 may calculate the VSWR without calculating the average values of the transmission power and the reflected wave power.

(Step S6) The VSWR calculator 45 supplies the calculated VSWR to the determiner 46.

As can be seen from the above description, the radio communication apparatus supplies to the circulator 13 the transmission signal output from the amplifier 11, and at the same time branches the transmission signal by using the coupler 41 and supplies it to the circulator 12.

The adder 17 adds the unnecessary wave phase-inverted by the phase shifter 16 output from the port p13 of the circulator 12 to the resultant wave output from the port p13 of the circulator 13, thereby acquiring the reflected wave. The SW 43 switches the transmission signal output from the port p12 of the circulator 12 and the reflected wave output from the adder 17 for output. The process permits the radio communication apparatus to calculate a VSWR based on a high-accuracy reflected wave and a transmission signal actually supplied to the antenna 15 and improve accuracy of the VSWR.

According to the proposed radio communication apparatus and reflected wave acquisition method, the amount of reflected wave is recognized with high accuracy.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A radio communication apparatus to perform radio communication, comprising:
a first output device including a first port, a second port, and a third port, and configured to output from the second port a transmission signal supplied to the first port;
a second output device including a first port, a second port, and a third port, and configured to output from the second port the transmission signal supplied to the first port, and output from the third port a reflected wave supplied to the second port from an antenna;
a phase shifter configured to invert a phase of a signal output from the third port of the first output device; and
an adder configured to add one signal output from the third port of the second output device and another signal output from the phase shifter.

2. The radio communication apparatus according to claim 1, wherein the first and second output devices have same characteristics.

3. The radio communication apparatus according to claim 1, wherein the transmission signal output from the second port of the first output device is supplied to the first port of the second output device.

4. The radio communication apparatus according to claim 1, wherein the transmission signal is supplied to the first port of the first output device through a coupler.

5. The radio communication apparatus according to claim 4, further comprising an attenuator configured to attenuate a signal output from the third port of the second output device.

6. The radio communication apparatus according to claim 4, further comprising a switch configured to output one of a signal output from the second port of the first output device and a signal output from the adder.

7. A reflected wave acquisition method for use in a radio communication apparatus to perform radio communication, the reflected wave acquisition method comprising:
in a first output device including a first port, a second port, and a third port,
outputting from the second port a transmission signal supplied to the first port;
in a second output device including a first port, a second port, and a third port,
outputting from the second port the transmission signal supplied to the first port and outputting from the third port a reflected wave supplied to the second port from an antenna;
inverting a phase of a signal output from the third port of the first output device; and
adding one signal output from the third port of the second output device and another signal a phase of which is inverted.
